(19) United States
(12) Patent Application Publication
(10) Pub. No.: US 2005/0223626 A1
(43) Pub. Date: Oct. 13, 2005

(54) Mosquito pipe

(76) Inventor: Anthony Allen Jabr, Murphysboro, IL (US)

Correspondence Address: ANTHONY ALLEN JABR, 435 SOUTH 15TH STREET, MURPHYSBORO, IL, 62966, US

(21) Appl. No.: 10/768,593

(22) Filed: Feb. 2, 2004

(51) Int. Cl. A01M 1/20

(52) U.S. Cl. 43/132.1

(57) ABSTRACT

The Mosquito Pipe dispenses a continuous curtain of citronella fumes along the length of the pipe by the placement of the multiple wicks. The continuous curtain of fumes begins a few inches above the Mosquito Pipe and extends upwards several feet in the air depending upon the wind speed. Citronella oil is administered in one end of the Pipe and is dispensed to eight or more wicks and, when lit, the fumes combine to form a curtain creating a more effective mosquito barrier.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

During the summer of 2002 the West Nile Virus spread across the continental US prompting the need for better mosquito repelling methods. The burning of citronella oil torches offers some measure of protection against mosquitoes, however, this method of dispersal leaves many gaps in the citronella vapor, giving opportunity for mosquitoes to penetrate the desired area of protection. The Mosquito Pipe is designed to address this deficiency of conventional citronella vapor dispersal, thereby producing a greater discouraging effect on mosquitoes.

### BRIEF SUMMARY OF THE INVENTION

The Mosquito Pipe produces a continuous citronella vapor barrier along the length of the pipe through the use of multiple wicks. The Mosquito Pipe produces vapor beginning low to the ground and extending upwards to create a more effective citronella vapor shield for repelling mosquitoes. This addresses the single most important deficiency of conventional citronella torches and candles of the vapor free areas adjacent to the torches or candles that allows unhindered passage of mosquitoes.

The Mosquito Pipe emits light and can be used to illuminate an area in its vicinity. The Mosquito Pipe illuminates the ground area surrounding the device sufficiently enough to discern ground hazards or illuminate a footpath.

Larger scaled Mosquito Pipes with larger diameters and larger wicks can be used as outdoor heaters.

### BRIEF DESCRIPTION OF THE SEVERAL VIEWS OF THE DRAWING

FIG. 1. Side view of the Mosquito Pipe.

FIG. 2. Side view of the Mosquito Pipe with elements labeled.

FIG. 3. Side view of the Mosquito Pipe with dimensions included.

FIG. 4. View from top of the Mosquito Pipe with dimensions.

FIG. 5. View from top of the Mosquito Pipe with elements labeled.

FIG. 6. Slightly elevated side view of the Mosquito Pipe showing the base and chain support.

FIG. 7. Side view of just base support with chain.

FIG. 8. View from top of just base support.

FIG. 9. Slightly elevated angular view of base support with chain holding a cut-away section of the Mosquito Pipe.

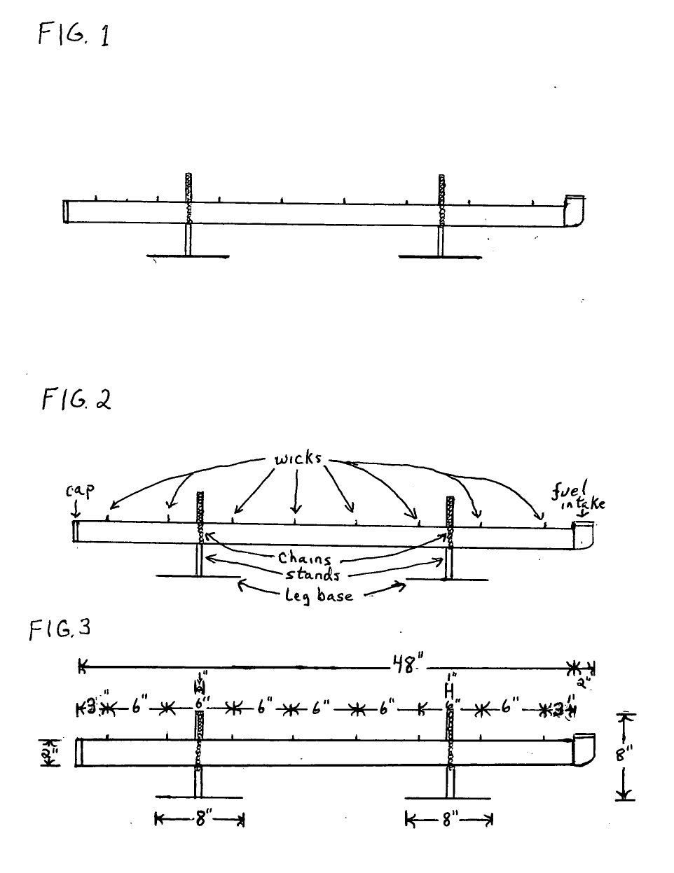

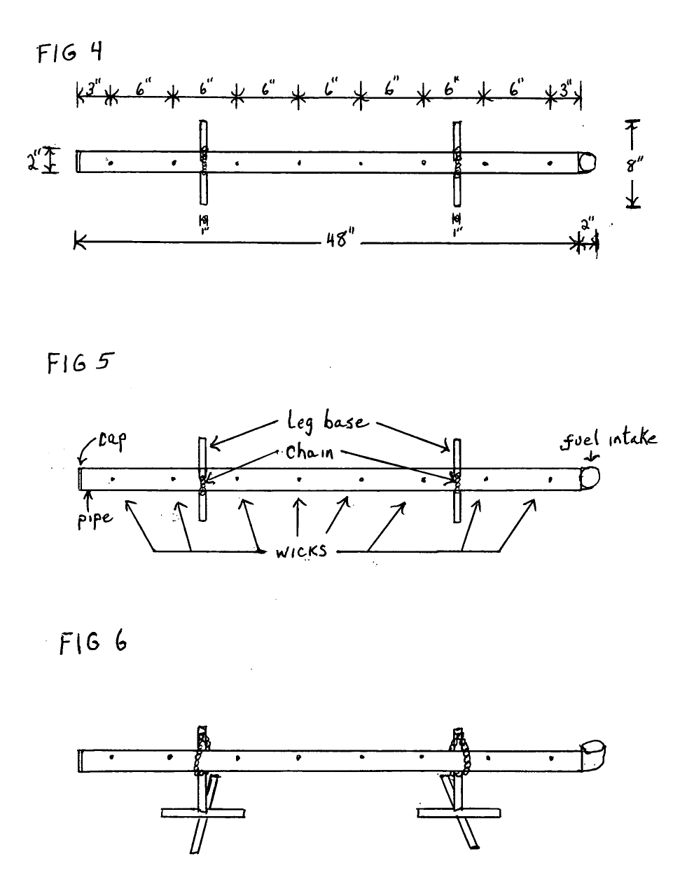

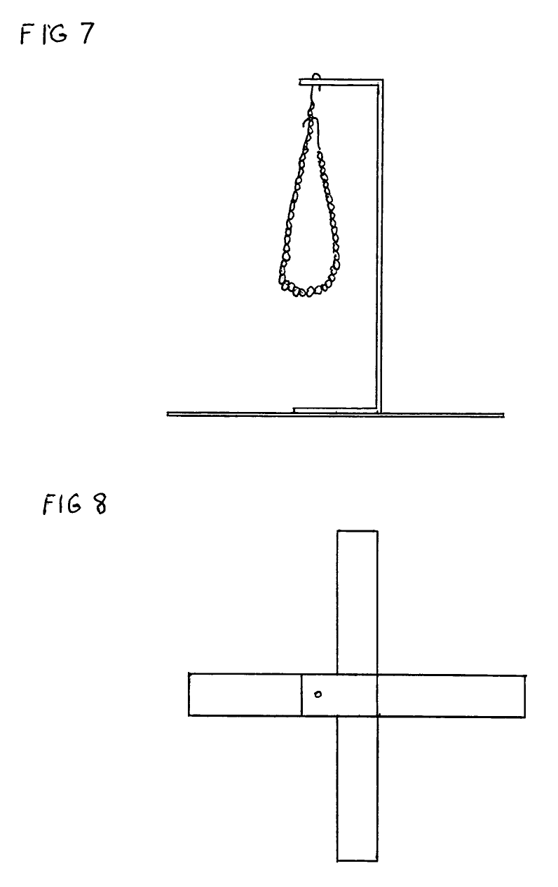

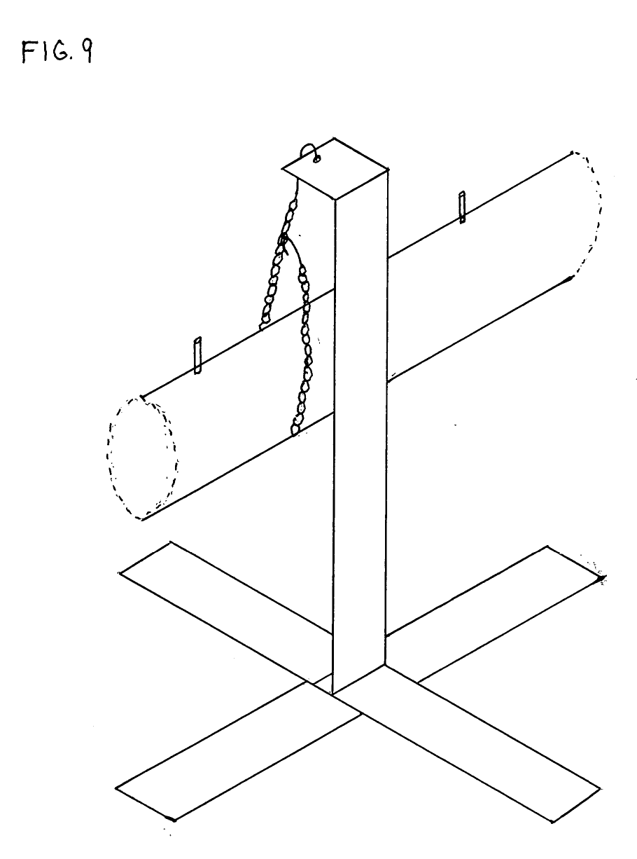

### DETAILED DESCRIPTION OF THE INVENTION

The Mosquito Pipe is a citronella oil burning device. It is a length of pipe that acts as the oil reservoir and has numerous wicks along its top edge. The pipe can be circular in dimension, square, rectangular or any other shape that allows a top surface plain suitable for wick burning. The consumer model is a four foot (48 inches) length of pipe and can range from one inch to two and a half inches in diameter, supported and suspended off the ground by two stands towards each end One end of the pipe is sealed and the other end has an upward bend up to 90 degrees extending just above the plain of the pipe to allow the administration of the oil into the pipe reservoir. Along the length of the upper side of the pipe are eight wicks spaced equally apart every six inches and beginning and ending three inches inwards from each end of the pipe. The wick holes can be drilled, punched or otherwise made along the top edge of the Mosquito Pipe. Wick hole diameters should match wick diameters for the various models, e.g. One eighth of one inch diameter holes for the same size wick for the consumer model. Larger commercial models can use half inch wicks in half inch holes spaced every twelve inches.

The Mosquito Pipe is supported off the ground by two leg assemblies. Each leg assembly is adjustable enabling the Mosquito Pipe to be leveled on uneven ground. Each leg assembly consists of two flat metal strips eight inches in length and one inch in width, connected together at their centers at perpendicular angles to form and ‘X’ that lays flat on the ground. Attached to the center of the ‘X’ is a flat strip of metal extending eight inches in height with a one inch 90 degree bend at each end. The 90 degree one inch bend can be attached to the ‘X’ by welding, rivet, nut and bolt or other method. Both one inch 90 degree bends extend in the same direction and the top bend has a one quarter inch hole drilled or punched in its center. A metal chain fifteen inches in length with a metal hook at each end is used to support the Mosquito Pipe. The hook at one end of the chain is inserted in the quarter inch hole at the top of the leg assembly. The chain is wrapped beneath the Mosquito Pipe and up again to the quarter inch hole where the second hook is inserted. Adjustments to the height of the Mosquito Pipe can be made by removing one hook from the hole and connecting it to any of the links on the chain. The chain wrapping of leg assemblies should be towards the ends of the four foot Mosquito Pipe.

1. A torch apparatus for burning citronella oil (or other insect repelling oils) comprising:
a horizontal fuel canister portion constructed of a length of pipe; and
the said length of pipe is approximately one and a half inches in diameter and approximately four feet in length; and
the top portion of said length of pipe has been drilled to accommodate wicks; and
said wicks being spaced approximately six inches apart in a single row along the entire upper length of said segment of pipe; and
the ends of said length of pipe extend vertically upper approximately one inch at a ninty degree angle to the horizontal length of pipe; and
said ends each have a removable cap, threaded or otherwise, to allow the introduction of the citronella fuel into the horizontal section of the pipe and when capped prevents contamination of said fuel; and
the said horizontal length of pipe, wicks, and vertically up turned ends are supported off the ground by means of two adjustable stands positioned approximately one foot from each end; and
said stands allow for the leveling of the horizontal section of the pipe when placed upon uneven ground; and
when said torch apparatus contains citronella oil and the wicks are lit, then the fumes merge together to create a continuous wall of fumes extending several feet upwards thereby creating a more effective barrier of citronella fumes for deterring mosquitos.
